(19) United States
(12) Patent Application Publication
(10) Pub. No.: US 2024/0303963 A1
(43) Pub. Date: Sep. 12, 2024

(54) QUAD-PIXEL IMAGE SENSOR IMBALANCE CORRECTION

(71) Applicant: CISTA SYSTEM CORP., Grand Cayman (KY)

(72) Inventors: Shenglong YANG, Taipei City (TW); Zhaojian LI, FREMONT, CA (US)

(21) Appl. No.: 18/118,632

(22) Filed: Mar. 7, 2023

(51) Int. Cl. G06V 10/75; G06T 7/40; G06V 10/60; G06V 10/74; H04N 25/46

(52) U.S. Cl. CPC G06V 10/751; G06T 7/40; G06V 10/60; G06V 10/761; H04N 25/46; G06T 2207/10024

(57) ABSTRACT

This application describes methods and systems for imbalance correction in quad image sensors. An exemplary method includes performing pixel value compensation at both inter-quaternion level and intra-quaternion level within a single pipeline. For example, the method may include obtaining an image captured by a quad image sensor and parameters of quaternions in the quad image sensor; computing a quad-pixel value bin and a standard deviation for each quaternion; performing inter-quad compensation among different quaternions using a cross-mean computed based on the plurality of pixel value bins and the plurality of standard deviations; computing texture weights for the plurality of quaternions based on the quad-pixel value bins; and performing intra-quad compensation among pixels within the quaternion based on the cross-mean and corresponding texture weight.

### TECHNICAL FIELD

The disclosure relates generally to methods and systems for imbalance correction in quad-pixel image sensors.

### BACKGROUND

Quad-pixel image sensor is a type of digital image sensor used in cameras or other imaging devices. It may include quad-pixel units, also called quaternions (or quad), each of which includes four pixels arranged in a square or rectangular pattern. Each of these pixels captures light from a different section of the image being captured, and their outputs are combined to create a single high-resolution image.

A major technical challenge for quad-pixel image sensors is how to minimize or correct process variations or imbalance in intra and inter quaternions. The variations and imbalance would result in visible artifacts in the final image captured by a quad image sensor, such as uneven brightness and color between the different parts of the image. The goal of the correction process is to smooth the differences in gain and offset between the individual image pixels within a quad, and between different quads. This disclosure describes a novel process for imbalance correction in quad-pixel image sensors.

### SUMMARY

Various embodiments of this specification may include hardware circuits, systems, and methods related to imbalance correction in quad-pixel image sensors.

In some aspects, the techniques described herein relate to a computer-implemented method for imbalance correction, including: obtaining an image captured by a quad image sensor and parameters of a plurality of quaternions in the quad image sensor (each of the plurality of quaternions includes four pixels), computing a quad-pixel value bin for each of the plurality of quaternions in the image to obtain a plurality of quad-pixel value bins, and obtaining a plurality of standard deviations for the plurality of quaternions based on the plurality of pixel value bins and the parameters of the plurality of quaternions. With the bins and standard deviations, the method may further include performing inter-quad compensation among different quaternions based on the plurality of pixel value bins and the plurality of standard deviations (the compensating includes computing a cross-mean between a given quaternion and one or more quaternions of an opposite color); computing texture weights for the plurality of quaternions based on the plurality of quad-pixel value bins; and performing intra-quad compensation among pixels within the given quaternion based on the cross-mean and a corresponding texture weight.

In some aspects, the inter-quad compensation is performed among quaternions of green-red (Gr) and green-blue (Gb), and the intra-quad compensation is performed among pixels of a same color within each of the plurality of quaternions.

In some aspects, the parameters of the plurality of quaternions are precomputed and prepopulated into a programmable memory, the programmable memory being accessible during imbalance correction.

In some aspects, the parameter for a quaternion includes a ratio of a standard deviation and a mean of pixel values in the quaternion.

In some aspects, the quad-pixel value bin for a given quaternion includes an average of pixel values in the given quaternion.

In some aspects, the obtaining the plurality of standard deviations for the plurality of quaternions based on the plurality of pixel value bins and the parameters of the plurality of quaternions includes: computing a standard deviation for a quaternion based on a product of a pixel value bin of the quaternion and the parameter corresponding to the quaternion.

In some aspects, if the given quaternion is a green-blue (Gb) quaternion, the one or more quaternions of the opposite color are one or more green-red (Gr) quaternions; and if the given quaternion is a green-red (Gr) quaternion, the one or more quaternions of the opposite color are one or more green-blue (Gb) quaternions.

In some aspects, the performing inter-quad compensation includes: for the given quaternion, computing a pixel value mean of the quaternion of the opposite color; determining a crosstalk value based on a difference between a pixel value mean of the given quaternion and the pixel value mean of the quaternion of the opposite color; determining a crosstalk weight, wherein the crosstalk weight is a function of a standard deviation of the quaternion; computing a weighted crosstalk value based on the crosstalk value and the crosstalk weight; compensating pixel values in the given quaternion based on the pixel value mean of the given quaternion and the weighted crosstalk value; and determining the cross-mean based on the pixel value mean of the quaternion and the weighted crosstalk value for subsequent intra-quad compensation.

In some aspects, the pixel value mean of the quaternion of the opposite color includes a luma-weighted average of the pixel values in the quaternion of the opposite color.

In some aspects, the computing texture weights for the plurality of quaternions based on the plurality of quad-pixel value bins includes: computing a texture difference between a given quaternion and neighboring quaternions; and determining the texture weight for the given quaternion based on the texture difference, wherein the texture weight is a function of the texture difference.

In some aspects, the computing the texture difference between the given quaternion and the neighboring quaternions: if the given quaternion is green, computing the texture difference between the given quaternion and four diagonal neighboring quaternions; and if the given quaternion is not green, computing the texture difference between the given quaternion and four non-diagonal neighboring quaternions.

In some aspects, the performing intra-quad compensation among pixels within the given quaternion based on the cross-mean and corresponding texture weight includes: determining a pixel value difference between a current pixel value and the cross-mean; determining an intra-quad weight based on the pixel value difference; computing an output value based on the pixel value difference, the intra-quad weight, and the corresponding texture weight; and replacing the current pixel value with the output value.

In some aspects, the intra-quad compensation is performed after the inter-quad compensation.

In some aspects, the techniques described herein relate to a system, including one or more processors and one or more non-transitory computer-readable memories coupled to the one or more processors and configured with instructions executable by the one or more processors to cause the system to perform operations including: obtaining an image captured by a quad image sensor and parameters of a plurality of quaternions in the quad image sensor, wherein each of the plurality of quaternions includes four pixels; computing a quad-pixel value bin for each of the plurality of quaternions in the image to obtain a plurality of quad-pixel value bins; obtaining a plurality of standard deviations for the plurality of quaternions based on the plurality of pixel value bins and the parameters of the plurality of quaternions; performing inter-quad compensation among different quaternions based on the plurality of pixel value bins and the plurality of standard deviations, wherein the compensating includes computing a cross-mean between a given quaternion and one or more quaternions of an opposite color; computing texture weights for the plurality of quaternions based on the plurality of quad-pixel value bins; and performing intra-quad compensation among pixels within the given quaternion based on the cross-mean and a corresponding texture weight.

In some aspects, the techniques described herein relate to a non-transitory computer-readable storage medium configured with instructions executable by one or more processors to cause the one or more processors to perform operations including: obtaining an image captured by a quad image sensor and parameters of a plurality of quaternions in the quad image sensor, wherein each of the plurality of quaternions includes four pixels; computing a quad-pixel value bin for each of the plurality of quaternions in the image to obtain a plurality of quad-pixel value bins; obtaining a plurality of standard deviations for the plurality of quaternions based on the plurality of pixel value bins and the parameters of the plurality of quaternions; performing inter-quad compensation among different quaternions based on the plurality of pixel value bins and the plurality of standard deviations, wherein the compensating includes computing a cross-mean between a given quaternion and one or more quaternions of an opposite color; computing texture weights for the plurality of quaternions based on the plurality of quad-pixel value bins; and performing intra-quad compensation among pixels within the given quaternion based on the cross-mean and a corresponding texture weight.

These and other features of the systems, methods, and hardware devices disclosed, and the methods of operation and functions of the related elements of structure and the combination of parts and economies of manufacture will become more apparent upon consideration of the following description and the appended claims referring to the drawings, which form a part of this specification, where like reference numerals designate corresponding parts in the figures. It is to be understood, however, that the drawings are for illustration and description only and are not intended as a definition of the limits of the invention.

### BRIEF DESCRIPTION OF THE DRAWINGS

FIG. 1 illustrates potential imbalance in a quad-pixel image sensor, according to some embodiments of this specification.

FIG. 2 illustrates an exemplary block diagram of a pipeline for quad-pixel image sensor imbalance correction, according to some embodiments of this specification.

FIG. 3 illustrates an exemplary diagram for binning quad-pixel units, according to some embodiments of this specification.

FIG. 4 illustrates an exemplary block diagram of a pipeline for inter-quad compensation, according to some embodiments of this specification.

FIG. 5 illustrates an exemplary diagram for determining texture weights for each quad unit, according to some embodiments of this specification.

FIG. 6 illustrates an exemplary intra-quad compensation, according to some embodiments of this specification.

FIG. 7 illustrates an exemplary method for quad-pixel image sensor imbalance correction, according to some embodiments of this specification.

FIG. 8 is a schematic diagram of an example computing system for quad-pixel image sensor imbalance correction, according to some embodiments of this specification.

### DETAILED DESCRIPTION

The specification is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present specification. Thus, the specification is not limited to the embodiments shown, but is to be accorded the widest scope consistent with the principles and features disclosed herein.

This disclosure describes a solution for mitigating potential variations or imbalances in quad-pixel image sensors. Here, the terms “variations” and “imbalance” are used interchangeably in this disclosure, both may include one or more pixels having deviation from standard or expected values. The deviations may be caused by variations in the sensitivity or responsivity of the pixels, interferences of neighboring pixels, interference from other electronic components in the system, etc. These variations can impact the overall image quality, causing color shading, noise, and other artifacts. Some example interferences may include cross-talk between the pixels and electronic crosstalk. Cross-talk occurs when the signal from one pixel leaks into an adjacent pixel, resulting in a reduction in the signal-to-noise ratio of the affected pixel. This can lead to a degradation of image quality, especially in low-light conditions. Electronic crosstalk can also occur when the electrical signals from the pixels interfere with each other, resulting in noise and image artifacts. This can be caused by a variety of factors, including differences in the electronic components used in the pixels, differences in the wiring and connections between the pixels, and differences in the layout of the pixels within the sensor. For simplicity, the following description uses “imbalance” to pixel value deviations caused by any of the above-described reasons.

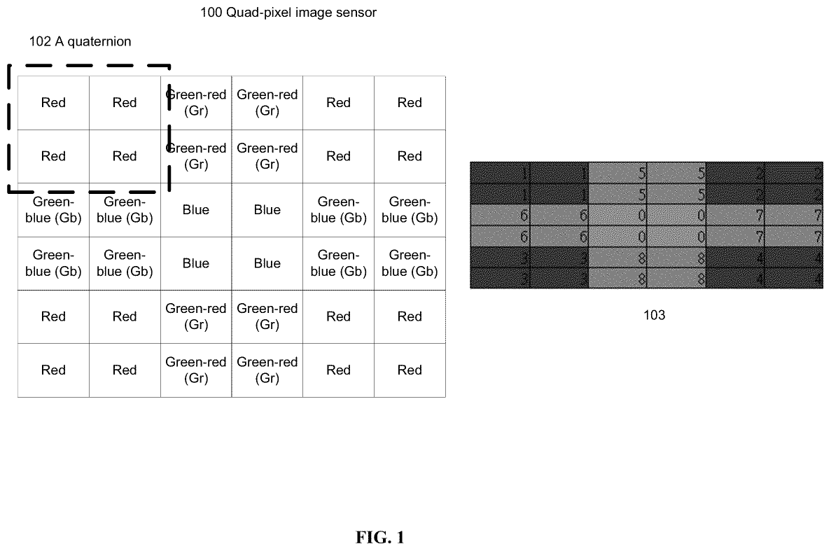

FIG. 1 illustrates potential imbalance in a quad-pixel image sensor 100, according to some embodiments of this specification. As shown, the quad-pixel image sensor 100 include a matrix of quad-pixel units, each of which may be called a quaternion 102 and comprises four pixels of the same color (e.g., the pixels use filters of the same color). These quad-pixel units are arranged in a specific pattern to provide a high level of color detail and sensitivity in the captured images. As an example, the quaternions 102 in the quad-pixel image sensor 100 are arranged in a Bayer pattern, which is a color filter array (CFA) used in digital imaging to capture color images. In this pattern, each mosaic includes a red quaternion, a green quaternion, another green quaternion, and a blue quaternion. The first green quaternion in the same row as the red quaternion may be referred to as green-red (Gr). The second green quaternion in the same row as the blue quaternion may be referred to as green-blue (Gb).

At high level, there are at least two types of variations. One is between the pixels of the same color id or within the same quaternion, called intra-quad variation. The other one is between Gr and Gb quaternions, called inter-quad variation. For ease of description, the quad-pixel image sensor 100 in FIG. 1 is represented as the matrix 103 with the pixels being labeled with color id. The intra-quad variation is among pixels of the same color id, and the inter-quad variation is among the quaternions with color ids 5, 6, 7, and 8, i.e., the Gr and Gb quaternions.

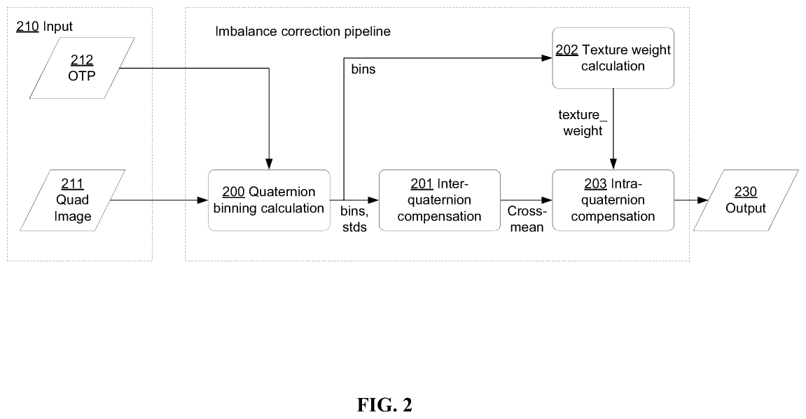

FIG. 2 illustrates an exemplary block diagram of a pipeline for quad-pixel image sensor imbalance correction, according to some embodiments of this specification. The pipeline may be implemented by a processing unit in a camera or a computing device equipped with quad-pixel image sensor. From a logical view, the pipeline may be implemented as an on-chip correction pipeline that automatically balance the pixel signal levels, or as a post-processing pipeline that is triggered after image capture. As shown, the imbalance correction pipeline accepts input 210 and generates output 230. The input 210 may include a quad-image 211 captured by a quad-pixel image sensor and data from a programmable memory, such as an one-time programmable memory 212. The output 230 may include a compensated quad image in which some of the pixels are compensated. Here, the compensation refers to adjusting the gain or offset (e.g., pixel value) of the pixel so that the signal levels of the pixels are smoothened, thereby reducing visual artifacts and improving the overall quality of the image.

In some embodiments, the data in the one-time programmable memory (OTP) 212 may include parameters of the plurality of quaternions in the quad-pixel image sensor (e.g., a quad-pixel image camera). The parameters may be precomputed and prepopulated into the OTP. The OTP is accessible during imbalance correction. In some embodiments, the parameters include a ratio of standard deviation and mean for each quaternion. For example, for a quaternion with four pixels (filters) 0_a, 0_b, 0_c, 0_d, the corresponding parameter may be a ratio of std(0_a, 0_b, 0_c, 0_d)/avg(0_a, 0_b, 0_c, 0_d), in which std stands for standard deviation and avg stands for average. Here, the standard deviation of four pixel values is a measure of the spread or dispersion of the pixel values around the mean. It may be calculated as the square root of the variance of the pixel values. These parameters may be learned during the stage of calibration of the image sensor and stored for computation during image correction. For example, for a given pixel-value average (e.g., representing the current brightness level) of a current quaternion, the standard deviation may be restored by multiplying the pixel-value average with the corresponding std/avg ratio, i.e., the parameter.

The imbalance correction pipeline may start after receiving the quad image 211 and the parameters from the OTP 212. In some embodiments, the imbalance correction pipeline may include a quaternion binning calculation module 200, an inter-quaternion compensation module 201, a texture weight calculation module 202, and an intra-quaternion compensation module 203. The quaternion binning calculation module 200 operates on each of the plurality of quaternions in the quad image 211, the inter-quaternion compensation module 201 operates on the green quaternions (more specifically, between Gr and Gb quaternions), the texture weight calculation module 202 operates on each of the plurality of quaternions in the quad image 211, and the intra-quaternion compensation module 203 operates on individual pixels within quaternions.

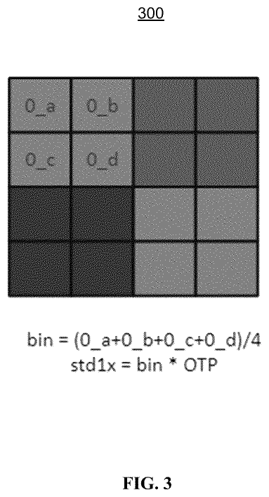

In some embodiments, the quaternion binning calculation module 200 may be configured to compute the signal intensity (e.g., brightness level) and a corresponding standard deviation for each quaternion. FIG. 3 illustrates an example process in a quaternion binning calculation module 200, according to some embodiments of this specification. In particular, the signal intensity may be represented as an average pixel value of the four pixels in the quaternion, denoted as a bin, and the standard deviation (denoted as std, e.g., stdlx represents the standard deviation for the first quaternion) may be obtained by multiplying the bin with the corresponding parameter from OTP.

Referring back to FIG. 2, the bins and stds may be fed into the inter-quaternion compensation module 201, and the bins may be fed into the texture weight calculation module 202.

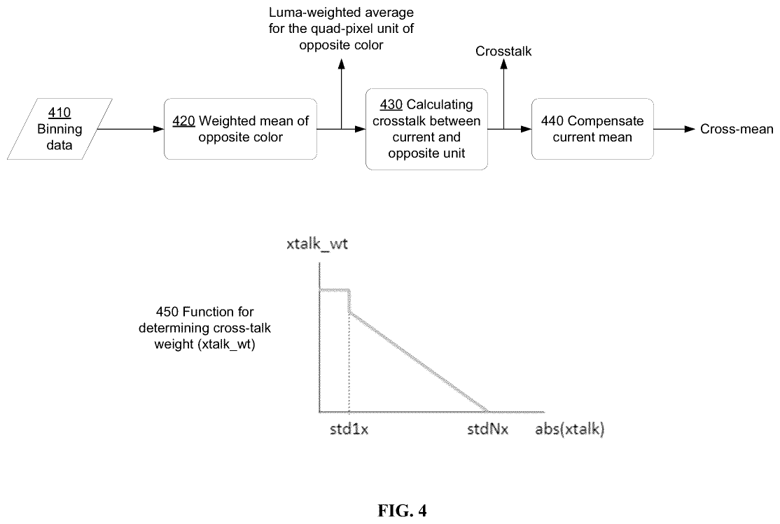

In some embodiments, the inter-quaternion compensation module 201 may be configured to compensate crosstalk between quaternions of opposite green colors. FIG. 4 illustrates an exemplary block diagram of a pipeline in inter-quaternion compensation module 201, according to some embodiments of this specification. As shown in FIG. 4, the bin data 410 is used to compute weighted mean of opposite color at step 420. If the pixel color of a processing quaternion is Gb, the opposite color is Gr, and vice versa. The mean of the opposite color quaternion may be luma-weighted average of the pixel values in the quaternion. Then the difference between the bin (e.g., the average pixel value) of the processing quaternion and the luma-weighted average of the opposite color quaternion may be computed as the crosstalk value at step 430. The crosstalk value may then be used to compensate the current mean (e.g., the bin) of the processing quaternion.

In some embodiments, to compensate the processing quaternion, the crosstalk value may be further weighted based on the standard deviation (std) of the processing quaternion. The crosstalk weight may be a function 450 of stds, as shown in FIG. 4. In some embodiments, crosstalk weight is inversely proportional to the stds.

With the crosstalk weight and the crosstalk value, a weighted crosstalk value may be obtained as a product of the crosstalk weight and the crosstalk value. The current pixel value mean of the processing quaternion may be compensated at step 440 based on the weighted crosstalk value. The compensation is based on a difference between the current pixel value mean of the processing quaternion and the weighted crosstalk value. This difference is also output by the pipeline as a cross-mean, which is further used in the subsequent modules. In some embodiments, the cross-mean is the pixel value mean of a given quaternion minus a weighted crosstalk value of the given quaternion.

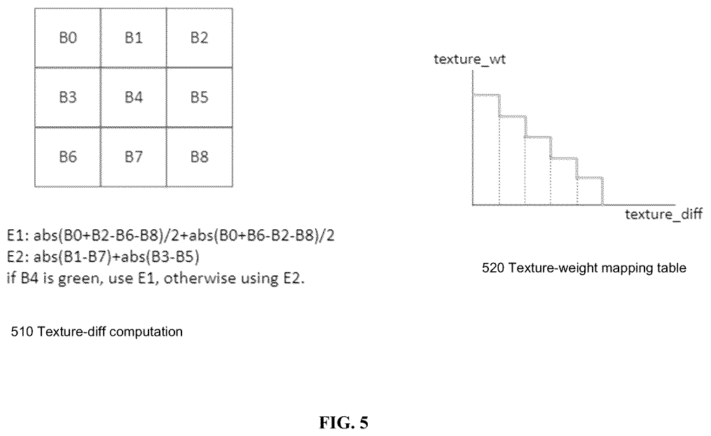

Referring back to FIG. 2, in some embodiments, after the inter-quaternion compensation occurs, the intra-quaternion compensation may be performed based on two sets of inputs: the cross-mean generated from the inter-quaternion compensation module 201 and texture weights generated from the texture weight calculation module 202. FIG. 5 illustrates an exemplary process in the texture weight calculation module 202 for determining texture weights for each quaternion, according to some embodiments of this specification. As shown in FIG. 5, for each quaternion, a texture difference between the quaternion and its neighboring quaternions may be computed. In some embodiments, if the quaternion is green, the texture difference between the quaternion and four diagonal neighboring quaternions may be computed as the texture difference of the quaternion. if the given quaternion is not green, the texture difference between the quaternion and four non-diagonal neighboring quaternions may be computed as the texture difference of the quaternion. For example, in the texture-diff computation diagram 510 in FIG. 5, if B4 is green (a bin value of a Gr or Gb quaternion), the texture difference for B4 (e.g., texture difference between B4 and its surrounding quaternion) may be computed using equation E1, which is based on the bins of B0, B2, B6, and B8, e.g., E1=abs(B0+B2−B6−B8)/2+abs(B0+B6−B2−B8)/2. If B4 is not green, the texture difference may be computed using equation E2, which is based on B1, B3, B5 and B7, e.g., E2=abs(b1−B7)+abs(B3−B5). The symbol abs means absolute value.

With the texture difference (denoted as texture_diff in FIG. 2) computed, a texture weight of the quaternion may be determined based on a mapping table. The example mapping table 520 in FIG. 5 shows that the texture weights (denoted as texture_wt) may be inversely proportional to the texture difference.

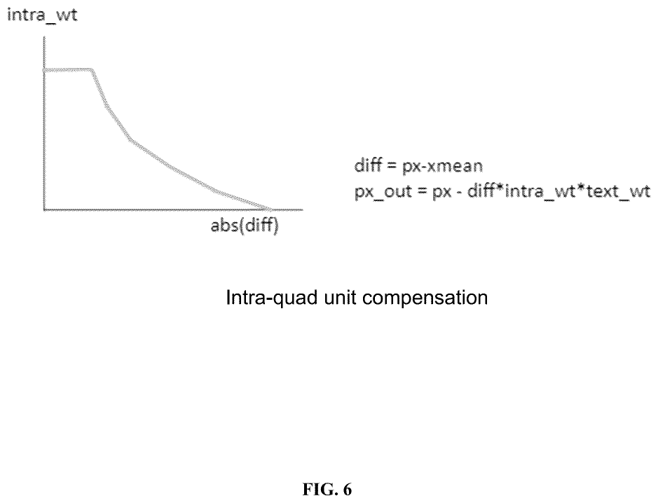

Referring back to FIG. 2 again, the intra-quaternion compensation module 203 may receive the cross-mean output from the inter-quaternion compensation module 201 and the texture-weight from the texture weight calculation module 202, and then perform compensation on each of the pixels in the processing quaternion. In some embodiments, the intra-quaternion compensation may involve computing a pixel value difference between a current pixel value (signal intensity) and the cross-mean, and compensating the current pixel based on the pixel value difference, the texture weight of the quaternion in which the current pixel is located, and an intra weight determined based on the pixel value difference. FIG. 6 illustrates an exemplary intra-quad compensation process, according to some embodiments of this specification. As shown, after the pixel value difference (denoted as diff) in computed, its absolute value (denoted as abs(diff) in FIG. 6) may be used to determine the intra weight, which may be inversely proportional to the absolute value of the pixel value difference. After that, the intra-quaternion compensation may be performed based on the distance between the pixel value difference and a product of pixel value difference, the intra weight, and the texture weight of the current quaternion. For instance, the current pixel value may be replaced with the computed distance (denoted as px_out in FIG. 6).

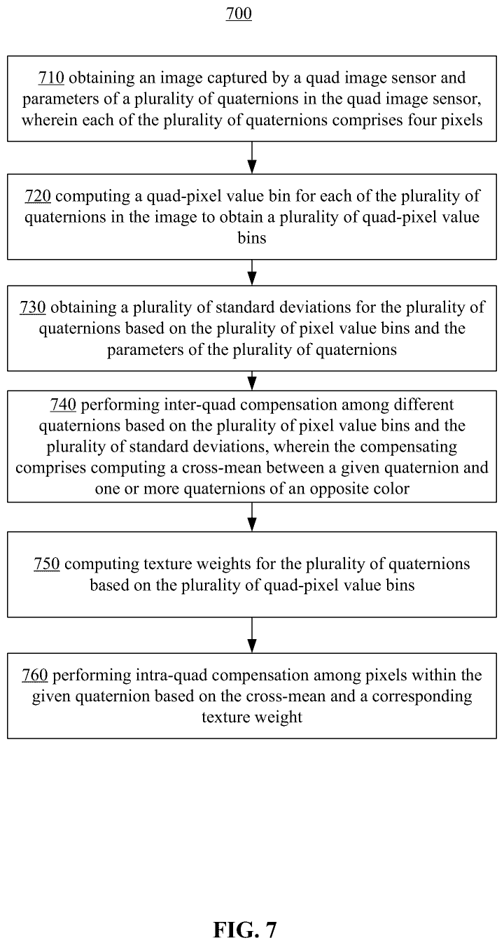

FIG. 7 illustrates an exemplary method for quad-pixel image sensor imbalance correction, according to some embodiments of this specification. The steps illustrated in FIG. 7 are for illustration purposes. Depending on the implementation, the method 700 may include fewer, more, or alternative steps.

The method 700 may include a plurality of steps. In some embodiments, step 710 includes obtaining an image captured by a quad image sensor and parameters of a plurality of quaternions in the quad image sensor, wherein each of the plurality of quaternions comprises four pixels. In some embodiments, the parameters of the plurality of quaternions are precomputed and prepopulated into a programmable memory, the programmable memory being accessible during imbalance correction. In some embodiments, the parameter for a quaternion comprises a ratio of a standard deviation and a mean of pixel values in the quaternion.

Step 720 includes computing a quad-pixel value bin for each of the plurality of quaternions in the image to obtain a plurality of quad-pixel value bins. In some embodiments, the quad-pixel value bin for a given quaternion comprises an average of pixel values in the given quaternion.

Step 730 includes obtaining a plurality of standard deviations for the plurality of quaternions based on the plurality of pixel value bins and the parameters of the plurality of quaternions. In some embodiments, the obtaining the plurality of standard deviations for the plurality of quaternions based on the plurality of pixel value bins and the parameters of the plurality of quaternions comprises: computing a standard deviation for a quaternion based on a product of a pixel value bin of the quaternion and the parameter corresponding to the quaternion.

Step 740 includes performing inter-quad compensation among different quaternions based on the plurality of pixel value bins and the plurality of standard deviations, wherein the compensating comprises computing a cross-mean between a given quaternion and one or more quaternions of an opposite color. In some embodiments, the inter-quad compensation is performed among quaternions of green-red (Gr) and green-blue (Gb), and the intra-quad compensation is performed among pixels of a same color within each of the plurality of quaternions. In some embodiments, if the given quaternion is a green-blue (Gb) quaternion, the one or more quaternions of the opposite color are one or more green-red (Gr) quaternions; and if the given quaternion is a green-red (Gr) quaternion, the one or more quaternions of the opposite color are one or more green-blue (Gb) quaternions.

In some embodiments, the performing inter-quad compensation comprises: for the given quaternion, computing a pixel value mean of the quaternion of the opposite color; determining a crosstalk value based on a difference between a pixel value mean of the given quaternion and the pixel value mean of the quaternion of the opposite color; determining a crosstalk weight, wherein the crosstalk weight is a function of a standard deviation of the quaternion; computing a weighted crosstalk value based on the crosstalk value and the crosstalk weight; compensating pixel values in the given quaternion based on the pixel value mean of the given quaternion and the weighted crosstalk value; and determining the cross-mean based on the pixel value mean of the quaternion and the weighted crosstalk value for subsequent intra-quad compensation.

Step 750 includes computing texture weights for the plurality of quaternions based on the plurality of quad-pixel value bins. In some embodiments, the computing texture weights for the plurality of quaternions based on the plurality of quad-pixel value bins comprises: computing a texture difference between a given quaternion and neighboring quaternions; and determining the texture weight for the given quaternion based on the texture difference, wherein the texture weight is a function of the texture difference.

Step 760 includes performing intra-quad compensation among pixels within the given quaternion based on the cross-mean and a corresponding texture weight. In some embodiments, the performing intra-quad compensation among pixels within the given quaternion based on the cross-mean and corresponding texture weight comprises: determining a pixel value difference between a current pixel value and the cross-mean; determining an intra-quad weight based on the pixel value difference; computing an output value based on the pixel value difference, the intra-quad weight, and the corresponding texture weight; and replacing the current pixel value with the output value. In some embodiments, the intra-quad compensation is performed after the inter-quad compensation.

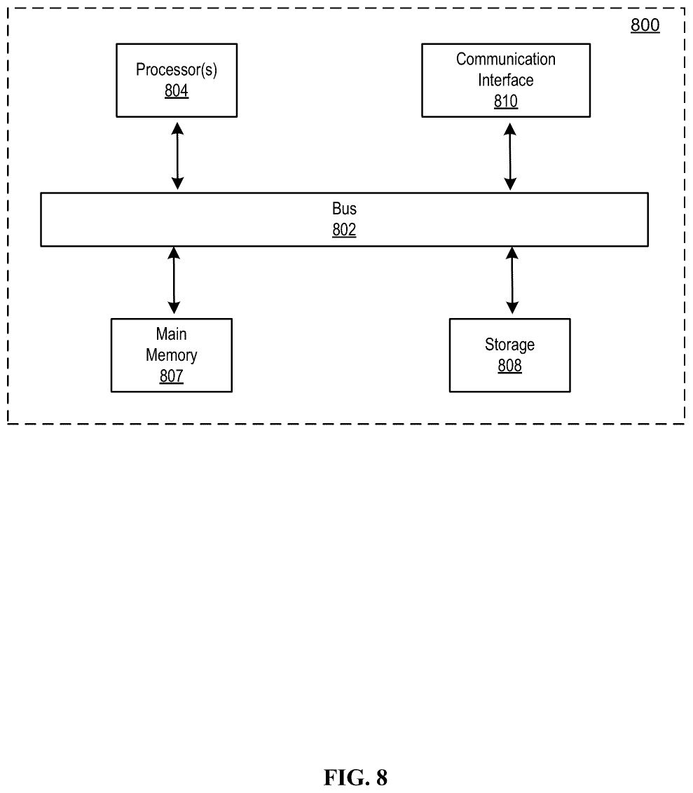

FIG. 8 is a schematic diagram of an example computing system for quad-pixel image sensor imbalance correction, according to some embodiments of this specification. The computer system 800 may be implemented in any of the components of the systems illustrated in FIGS. 1-7. One or more of the example methods illustrated by FIGS. 1-7 may be performed by one or more implementations of the computer system 800.

The computer system 800 may include a bus 802 or other communication mechanism for communicating information, and one or more hardware processor(s) 804 coupled with bus 802 for processing information. Hardware processor(s) 804 may be, for example, one or more general purpose microprocessors.

The computer system 800 may also include a main memory 807, such as a random-access memory (RAM), cache and/or other dynamic storage devices, coupled to bus 802 for storing information and instructions executable by processor(s) 804. Main memory 807 also may be used for storing temporary variables or other intermediate information during execution of instructions by processor(s) 804. Such instructions, when stored in storage media accessible to processor(s) 804, render computer system 800 into a special-purpose machine that is customized to perform the operations specified in the instructions. The computer system 800 may further include a read only memory (ROM) 807 or other static storage device coupled to bus 802 for storing static information and instructions for processor(s) 804. A storage device 808, such as a magnetic disk, optical disk, or USB thumb drive (flash drive), etc., may be provided and coupled to bus 802 for storing information and instructions.

The computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the operations, methods, and processes described herein are performed by computer system 800 in response to processor(s) 804 executing one or more sequences of one or more instructions contained in main memory 807. Such instructions may be read into main memory 807 from another storage medium, such as storage device 808. Execution of the sequences of instructions contained in main memory 807 may cause processor(s) 804 to perform the process steps described herein. In alternative embodiments, hard-wired circuitry may be used in place of or in combination with software instructions.

The main memory 807, the ROM 807, and/or the storage device 808 may include non-transitory storage media. The term “non-transitory media,” and similar terms, as used herein refers to media that stores data and/or instructions that cause a machine to operate in a specific fashion, that excludes transitory signals. Such non-transitory media may comprise non-volatile media and/or volatile media. Non-volatile media includes, for example, optical or magnetic disks, such as storage device 808. Volatile media includes dynamic memory, such as main memory 807. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 800 may include a network interface 810 coupled to bus 802. Network interface 810 may provide a two-way data communication coupling to one or more network links that are connected to one or more local networks. For example, network interface 810 may be an integrated services digital network (ISDN) card, cable modem, satellite modem, or a modem that provides a data communication connection to a corresponding type of telephone line. As another example, network interface 810 may be a local area network (LAN) card to provide a data communication connection to a compatible LAN (or WAN component to communicated with a WAN). Wireless links may also be implemented. In any such implementation, network interface 810 may send and receive electrical, electromagnetic or optical signals that carry digital data streams representing various types of information.

The computer system 800 can send messages and receive data, including program code, through the network(s), network link, and network interface 810. In the Internet example, a server might transmit a requested code for an application program through the Internet, the ISP, the local network, and the network interface 810.

The received code may be executed by processor(s) 804 as it is received, and/or stored in storage device 808, or other non-volatile storage for later execution.

Each process, method, and algorithm described in the preceding sections may be embodied in, and fully or partially automated by, code modules executed by one or more computer systems or computer processors comprising computer hardware. The processes and algorithms may be implemented partially or wholly in the application-specific circuit.

When the functions disclosed herein are implemented in the form of software functional units and sold or used as independent products, they can be stored in a processor executable non-volatile computer-readable storage medium. Particular technical solutions disclosed herein (in whole or in part) or aspects that contribute to current technologies may be embodied in the form of a software product. The software product may be stored in a storage medium, comprising a number of instructions that cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, where the terminal device may be a mobile terminal, a personal computer (PC), or any device that may be installed with a platform application program.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of example methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a prediction model that performs the function.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or sections of code which include one or more executable instructions for implementing specific logical functions or steps in the process. Alternate implementations are included within the scope of the embodiments described herein in which elements or functions may be deleted or executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A computer-implemented method for imbalance correction, comprising:
obtaining an image captured by a quad image sensor and parameters of a plurality of quaternions in the quad image sensor, wherein each of the plurality of quaternions comprises four pixels;
computing a quad-pixel value bin for each of the plurality of quaternions in the image to obtain a plurality of quad-pixel value bins;
obtaining a plurality of standard deviations for the plurality of quaternions based on the plurality of pixel value bins and the parameters of the plurality of quaternions;
performing inter-quad compensation among different quaternions based on the plurality of pixel value bins and the plurality of standard deviations, wherein the compensating comprises computing a cross-mean between a given quaternion and one or more quaternions of an opposite color;
computing texture weights for the plurality of quaternions based on the plurality of quad-pixel value bins; and
performing intra-quad compensation among pixels within the given quaternion based on the cross-mean and a corresponding texture weight.

2. The computer-implemented method of claim 1, wherein the inter-quad compensation is performed among quaternions of green-red (Gr) and green-blue (Gb), and the intra-quad compensation is performed among pixels of a same color within each of the plurality of quaternions.

3. The computer-implemented method of claim 1, wherein the parameters of the plurality of quaternions are precomputed and prepopulated into a programmable memory, the programmable memory being accessible during imbalance correction.

4. The computer-implemented method of claim 1, wherein the parameter for a quaternion comprises a ratio of a standard deviation and a mean of pixel values in the quaternion.

5. The computer-implemented method of claim 1, wherein the quad-pixel value bin for a given quaternion comprises an average of pixel values in the given quaternion.

6. The computer-implemented method of claim 1, wherein the obtaining the plurality of standard deviations for the plurality of quaternions based on the plurality of pixel value bins and the parameters of the plurality of quaternions comprises:
computing a standard deviation for a quaternion based on a product of a pixel value bin of the quaternion and the parameter corresponding to the quaternion.

7. The computer-implemented method of claim 1, wherein:
if the given quaternion is a green-blue (Gb) quaternion, the one or more quaternions of the opposite color are one or more green-red (Gr) quaternions; and
if the given quaternion is a green-red (Gr) quaternion, the one or more quaternions of the opposite color are one or more green-blue (Gb) quaternions.

8. The computer-implemented method of claim 1, wherein the performing inter-quad compensation comprises:
for the given quaternion, computing a pixel value mean of the quaternion of the opposite color;
determining a crosstalk value based on a difference between a pixel value mean of the given quaternion and the pixel value mean of the quaternion of the opposite color;
determining a crosstalk weight, wherein the crosstalk weight is a function of a standard deviation of the quaternion;
computing a weighted crosstalk value based on the crosstalk value and the crosstalk weight;
compensating pixel values in the given quaternion based on the pixel value mean of the given quaternion and the weighted crosstalk value; and
determining the cross-mean based on the pixel value mean of the quaternion and the weighted crosstalk value for subsequent intra-quad compensation.

9. The computer-implemented method of claim 8, wherein the pixel value mean of the quaternion of the opposite color comprises a luma-weighted average of the pixel values in the quaternion of the opposite color.

10. The computer-implemented method of claim 1, wherein the computing texture weights for the plurality of quaternions based on the plurality of quad-pixel value bins comprises:
computing a texture difference between a given quaternion and neighboring quaternions; and
determining the texture weight for the given quaternion based on the texture difference, wherein the texture weight is a function of the texture difference.

11. The computer-implemented method of claim 10, wherein the computing the texture difference between the given quaternion and the neighboring quaternions:
if the given quaternion is green, computing the texture difference between the given quaternion and four diagonal neighboring quaternions; and
if the given quaternion is not green, computing the texture difference between the given quaternion and four non-diagonal neighboring quaternions.

12. The computer-implemented method of claim 1, wherein the performing intra-quad compensation among pixels within the given quaternion based on the cross-mean and corresponding texture weight comprises:
determining a pixel value difference between a current pixel value and the cross-mean;
determining an intra-quad weight based on the pixel value difference;
computing an output value based on the pixel value difference, the intra-quad weight, and the corresponding texture weight; and
replacing the current pixel value with the output value.

13. The computer-implemented method of claim 1, wherein the intra-quad compensation is performed after the inter-quad compensation.

14. A system, comprising one or more processors and one or more non-transitory computer-readable memories coupled to the one or more processors and configured with instructions executable by the one or more processors to cause the system to perform operations comprising:
obtaining an image captured by a quad image sensor and parameters of a plurality of quaternions in the quad image sensor, wherein each of the plurality of quaternions comprises four pixels;
computing a quad-pixel value bin for each of the plurality of quaternions in the image to obtain a plurality of quad-pixel value bins;
obtaining a plurality of standard deviations for the plurality of quaternions based on the plurality of pixel value bins and the parameters of the plurality of quaternions;
performing inter-quad compensation among different quaternions based on the plurality of pixel value bins and the plurality of standard deviations, wherein the compensating comprises computing a cross-mean between a given quaternion and one or more quaternions of an opposite color;
computing texture weights for the plurality of quaternions based on the plurality of quad-pixel value bins; and
performing intra-quad compensation among pixels within the given quaternion based on the cross-mean and a corresponding texture weight.

15. The system of claim 14, wherein the inter-quad compensation is performed among quaternions of green-red (Gr) and green-blue (Gb), and the intra-quad compensation is performed among pixels of a same color within each of the plurality of quaternions.

16. The system of claim 14, wherein the performing inter-quad compensation comprises:
for the given quaternion, computing a pixel value mean of the quaternion of the opposite color;
determining a crosstalk value based on a difference between a pixel value mean of the given quaternion and the pixel value mean of the quaternion of the opposite color;
determining a crosstalk weight, wherein the crosstalk weight is a function of a standard deviation of the quaternion;
computing a weighted crosstalk value based on the crosstalk value and the crosstalk weight;
compensating pixel values in the given quaternion based on the pixel value mean of the given quaternion and the weighted crosstalk value; and
determining the cross-mean based on the pixel value mean of the quaternion and the weighted crosstalk value for subsequent intra-quad compensation.

17. The system of claim 16, wherein the pixel value mean of the quaternion of the opposite color comprises a luma-weighted average of the pixel values in the quaternion of the opposite color.

18. The system of claim 14, wherein the computing texture weights for the plurality of quaternions based on the plurality of quad-pixel value bins comprises:
computing a texture difference between a given quaternion and neighboring quaternions; and
determining the texture weight for the given quaternion based on the texture difference, wherein the texture weight is a function of the texture difference.

19. The system of claim 18, wherein the computing the texture difference between the given quaternion and the neighboring quaternions:
if the given quaternion is green, computing the texture difference between the given quaternion and four diagonal neighboring quaternions; and
if the given quaternion is not green, computing the texture difference between the given quaternion and four non-diagonal neighboring quaternions.

20. A non-transitory computer-readable storage medium configured with instructions executable by one or more processors to cause the one or more processors to perform operations comprising:
obtaining an image captured by a quad image sensor and parameters of a plurality of quaternions in the quad image sensor, wherein each of the plurality of quaternions comprises four pixels;
computing a quad-pixel value bin for each of the plurality of quaternions in the image to obtain a plurality of quad-pixel value bins;
obtaining a plurality of standard deviations for the plurality of quaternions based on the plurality of pixel value bins and the parameters of the plurality of quaternions;
performing inter-quad compensation among different quaternions based on the plurality of pixel value bins and the plurality of standard deviations, wherein the compensating comprises computing a cross-mean between a given quaternion and one or more quaternions of an opposite color;
computing texture weights for the plurality of quaternions based on the plurality of quad-pixel value bins; and
performing intra-quad compensation among pixels within the given quaternion based on the cross-mean and a corresponding texture weight.
